(19) United States
(12) Patent Application Publication
(10) Pub. No.: US 2015/0113790 A1
(43) Pub. Date: Apr. 30, 2015

(54) CLAMPING DEVICE FOR MACHINE TOOLS

(71) Applicant: MTH GbR, Markus und Thomas Hiestand, Pfullendorf (DE)

(72) Inventor: Karl Hiestand, Pfullendorf (DE)

(21) Appl. No.: 14/522,110

(22) Filed: Oct. 23, 2014

(30) Foreign Application Priority Data
Oct. 30, 2013 (DE) 13190861.8

(51) Int. Cl. B23B 31/175

(52) U.S. Cl. CPC B23B 31/16229; B23B 2231/12; B23B 2231/26; B23B 2231/42
USPC 29/559; 279/134; 279/126

(57) ABSTRACT

A clamping device for machine tools, the device provided with a power-operated chuck, an electrical drive motor, and a movement converter, with force accumulator. An output element is rotatably mounted on the output shaft of the drive motor, and is in driving connection with the movement converter. The output element is adapted to be connected to the output shaft by a servo device, and the movement converter can be interlocked with the spindle of the machine tool by a second servo device.

It is thus possible to clamp or unclamp a workpiece. During working procedures, the drive motor is stopped. There is no need for elaborate control functions, rather the servo devices are actuated to make a driving connection between the drive motor and the movement converter, or to release this connection, and to block the movement converter during working procedures by means of its connection to the spindle of the machine tool.

### BACKGROUND OF THE INVENTION

1. Field of the Invention

The present invention relates to a clamping device for machine tools the device being provided with a power-operated chuck for holding a workpiece, clamping jaws of which can be actuated using the clamping device by means of an axially moveable to draw rod, in which the clamping device possesses an electric drive motor with a changeover function for triggering clamping movements, a movement converter for converting the adjustment movements of the rotor shaft of the drive motor into the axial adjustment movements of the draw rod required for actuating the clamping jaws, as well as a force accumulator for maintaining the clamping force and which is comprises preloaded spring packs supported on a spindle nut of the movement converter, as well as to a process for operating a clamping device of this kind.

2. Description of the Prior Art

A clamping device of this kind is disclosed in EP 2103368 A1. The design structure of this clamping device is such that an externally arranged drive motor is connected, via a belt drive, to a bell housing in a driving connection, and the bell housing acts on a draw rod via a movement converter.

### SUMMARY OF THE INVENTION

In order to exclude an unwanted axial movement of the draw rod, the drive motor, together with the spindle of the machine tool, must be driven synchronously. The control function to achieve this synchronisation is extremely elaborate. Also, if there is a change of direction of rotation of the machine tool, the drive motor must continuously retain the direction of rotation with a high torque to the point of standstill, and after a change of direction of rotation, the direction of rotation and torque must be reversed. Furthermore, it is a disadvantage that the particular required high torque has to be transferred across the entire speed range of the machine tool by means of the belt drive. Damage to the belt drive often results from this, and the high load on the transmission element must be secured by additional measures so as to avoid downtimes and damage to the clamping devices to a large extent. The object of the present invention is, therefore, to create a clamping device for machine tools of the aforementioned type, such that an elaborate control function for adapting to the particular operating status of the machine tool is not required, rather no drive energy should be taken from the drive motor during working procedures. Instead, the drive motor should be at a standstill. Furthermore, a change of direction of rotation of the rotor shaft of the drive motor should not be required when there is a change of direction of rotation of the machine tool, and the load on the transmission elements between the drive motor and the movement converter should be kept at an extremely low level, with the effect that damage to these elements, especially breakage of the belt drive, is excluded to a large extent. Nevertheless, possible damage should not influence the safety of the clamping procedures. Furthermore, it should be possible for the clamping force to be changed at any speed during the working procedure.

In accordance with the present invention, this is achieved in a clamping device for machine tools of the aforementioned type in that an output element is mounted on a rotating arrangement on the output shaft of the rotor, and is continuously in a driving connection with the movement converter, that the output element can be connected to the output shaft of the rotor by means of a first servo device, and that the movement converter can be interlocked with the spindle of the machine tool by means of a second servo device, either directly or via intermediate elements.

In this case, it is advantageous for the movement converter and the force accumulator to be inserted in a bell-shaped housing which is in a driving connection with the output element of the rotor, in which case the housing should be connected in a positive connection to the spindle nut of the movement converter, for example, by cam-shaped drivers or gearing.

In accordance with a different design configuration, the drive energy can also be transferred to the spindle nut of the movement converter by providing an intermediate element that is connected via the belt drive to the output element of the drive motor and, possibly, in a positive connection with the spindle nut via a driver, preferably arranged at the side next to the movement converter.

In order to provide a driving connection between the output element and the housing of the movement converter, it is possible to provide a belt drive, in particular a toothed belt drive or a gear connection, in which case the driving connection between the output element of the drive motor and the housing of the movement converter can be configured with a step-down, step-up or 1:1 ratio.

The first and/or second servo device can be configured in each case as an electromagnetically, or pneumatically, or hydraulically operated clutch. In an electromagnetically operated servo device, the engageable components can be connected by means of friction elements, toothed discs preferably provided with pointed gearing, or discs, equipped with fluting and knurling. It is also advantageous for the armature of the electromagnetically operated clutch to be supported against the output element by one or more return springs.

Furthermore, it is appropriate for the second servo device to be equipped with an adjusting ring connected to the housing of the movement converter in a rotationally fixed arrangement, in which case on the side of the adjusting ring facing the spindle of the machine tool, the adjusting ring is provided with gearing, or a friction lining, that interacts with mating gearing, or another friction lining, provided on the spindle, in which case the adjusting element of the second servo device should be in a driven connection with the adjusting ring by means of one or more radially aligned pins preferably provided with anti-friction bearings, or by means of an angle piece.

In the configuration of the first servo device as an electromagnetically operated clutch, it should consist of a first housing component located in a fixed arrangement and holding the magnetic coil, and a second housing component mounted so as to be adapted to turn in relation to the first housing component, in which case the second housing component is in a permanent connection with the rotor shaft of the drive motor. Furthermore, the armature of the electromagnetically operated clutch should be coupled to the output element of the drive motor in a rotationally rigid but axially movable arrangement, and the first servo device should be arranged in a housing together with the output element of the drive motor, with the drive motor flange-mounted on the outside of the housing. Furthermore, when the first servo device is configured as an electromagnetically operated clutch, the housing facing the drive motor should be provided with an insert configured as a hub upon which the output element is mounted in a rotating arrangement.

According to a further configuration variant, there is provision for the housing accommodating the movement converter to be mounted in a rotating arrangement on an intermediate piece in a permanent connection with the spindle of the machine tool.

According to a further embodiment, however, the rotor of the drive motor can also be mounted in a rotating arrangement directly on the housing accommodating the movement converter, in which case the armature of the electromagnetically operated servo device should be axially movable directly on the rotor of the drive motor and the components, including the magnetic coil, should be supported on an intermediate piece attached to the housing of the movement converter.

The drive motor, the first servo device, as well as the second servo device, should be jointly controllable by means of a central computing unit, for which purpose it is possible for a distance measuring device, and/or one or more limit switches, to be allocated to the adjusting element of the movement converter, the signals from which can be picked off outside the housing of the movement converter. Also, a distance measuring device can be allocated to the draw rod, preferably arranged in its end area facing away from the machine tool.

The first servo device and the second servo device in this clamping device can be interconnected in the same direction, or in parallel, or alternately, by means of a common computing unit, by straightforward means depending on the operating status of the clamping device, such that when the first servo unit is activated to transfer drive energy to the movement converter, the rotor shaft of the drive motor is connected to its output element and the second servo device is also activated, meaning that the interlock between the housing and the spindle of the machine tool is released, and that when there is a modification in the working procedure of the machine tool, for example when clamping or unclamping the workpiece, the first servo unit is depressurised, the second servo device is also depressurised or, in a double-action servo device, activated, and the housing of the movement converter is in a driving connection with the spindle of the machine tool.

If a clamping device for machine tools is configured according to the present invention wherein the drive motor is in a driving connection with the movement converter and this converter can be activated or deactivated, then it is possible in a straightforward way to supply energy to the clamping device for clamping or unclamping a workpiece, while however, stopping the drive motor during working procedures. There is no need for elaborate control functions for this purpose, instead the two servo devices are to be actuated accordingly in each case so as to connect the drive motor to the movement converter in a driving connection or to release this connection, and to block the movement converter during working procedures through a connection to the spindle of the machine tool.

The components involved in energy transmission are thus only exposed to load for a short period; damage to them is thus practically excluded during operation. Nevertheless, the clamping device is always secured without the need for particular precautions to be taken, because during working procedures the movement converter is permanently connected to the spindle of the machine tool, thereby preventing the workpiece from coming unclamping by itself. As a result, high operational safety is provided over a long service life.

Furthermore, the clamping device configured in accordance with the invention has a straightforward design and can thus be manufactured economically; furthermore, it only takes up a small amount of space, meaning that versatile use is guaranteed advantageously and with a high level of reliability.

### BRIEF DESCRIPTION OF THE DRAWINGS

The drawings show the clamping device for machine tools configured in accordance with the present invention, as well as variations, the details of which are explained below. In the drawings,

FIG. 1 shows a clamping device mounted on a machine tool in an axial section during a machining procedure,

FIG. 2 shows the clamping device in accordance with FIG. 1 in a partial section and magnified view, during the transmission of drive energy to the clamping device,

FIG. 3 shows a sample embodiment of the clamping device in a partial section during a machining procedure,

FIG. 4 shows another sample embodiment of the clamping device in accordance with FIG. 1, with different kinds of servo devices, also during a machining procedure,

FIG. 5 shows a clamping device in accordance with FIG. 1, with a drive motor arranged directly on the movement converter, also during a machine procedure, and

FIG. 6 shows a further embodiment of the clamping device in accordance with FIG. 1.

### DESCRIPTION OF THE PREFERRED EMBODIMENTS

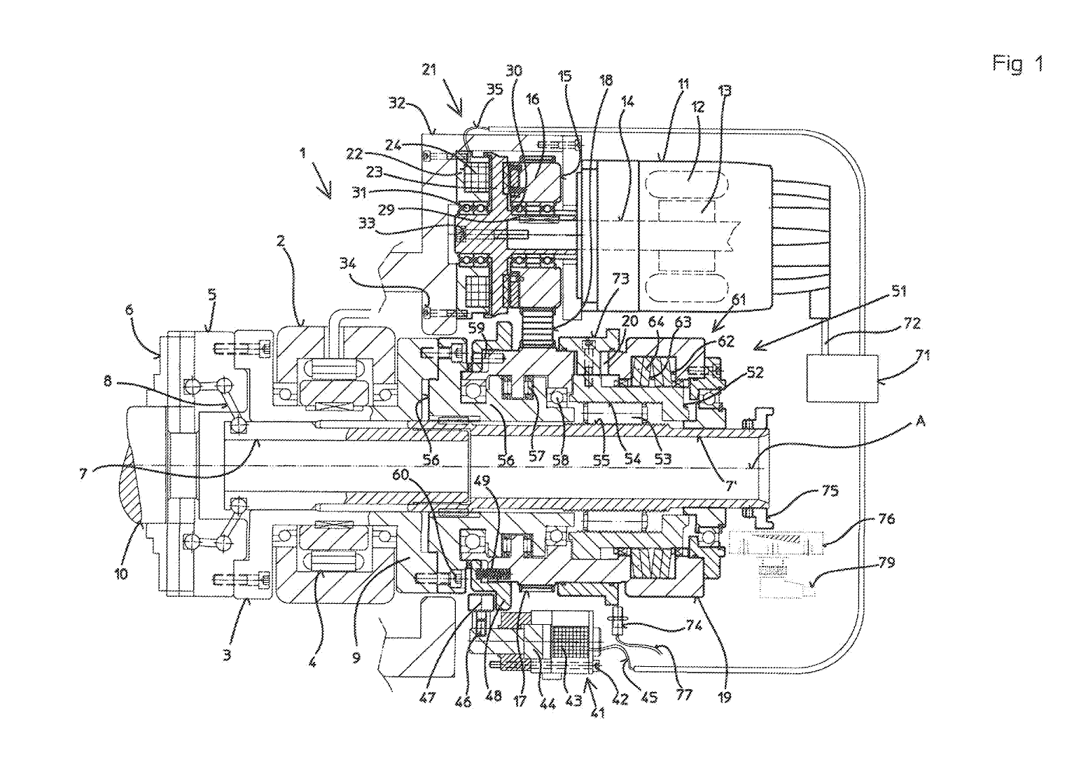

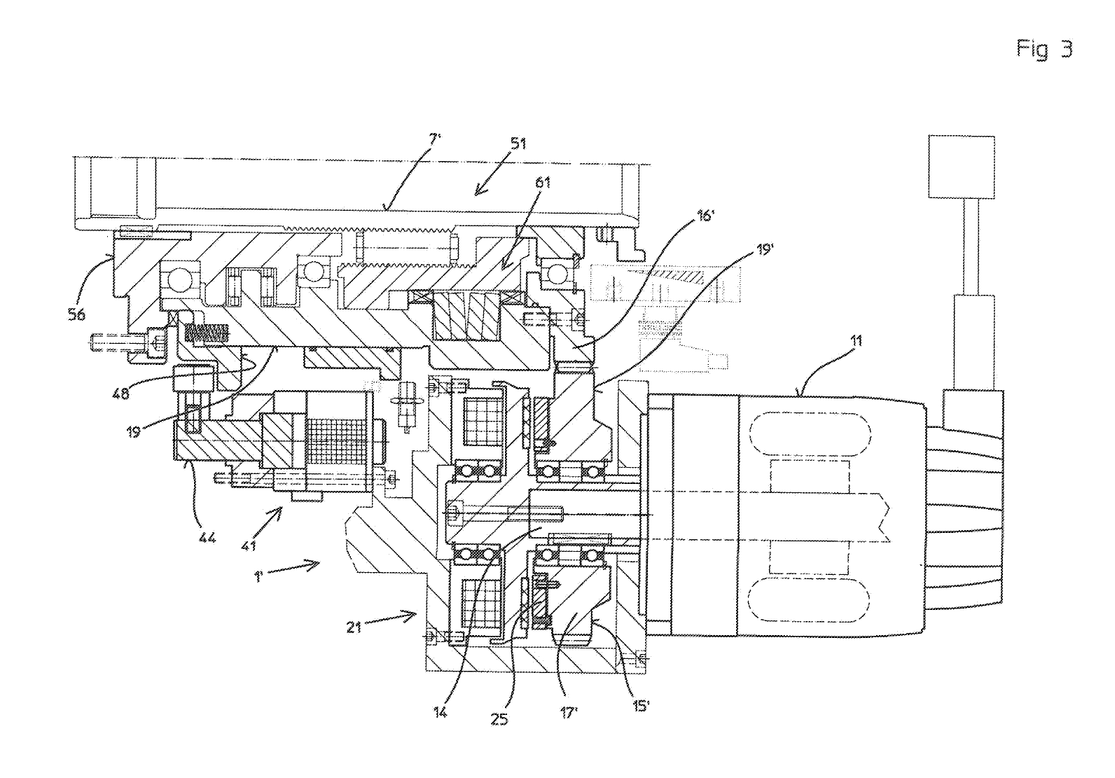

The clamping device illustrated in FIGS. 1 to 6, and identified by 1, 1′, 1″ or 1′″, is used for actuating a power-operated chuck 5 arranged on a machine tool 2 equipped with an electric motor 4, by means of radially adjustable clamping jaws 6 by which a workpiece 10 to be machined, can be clamped in the chuck 5. The clamping jaws 6 of the power-operated chuck 5 in this case can be actuated via relay levers 8 by an axially adjustable, two-part draw rod 7, 7′ in a driving connection with an electric drive motor 11 or 101 that has a changeover function, by means of a movement converter 51. The movement converter 51 converts the rotational adjustment movements of the drive motor 11 into axial feed movements of the draw rod 7, 7′.

The drive motor 11 in this case comprises a stator 12 in a fixed location located with its axis in parallel to the lengthways axis A of the clamping device 1, and of a rotor 13 with an output element 15 arranged on the output shaft 14 of the rotor 13, with the output element 15 in a rotating mounting, and in a permanent driving connection, with the movement converter 51. For this purpose, in the embodiment shown in FIGS. 1, 2 and 4, there is a belt drive composed of the output element 15 which is configured as a belt pulley 16, as well as a belt pulley 17 attached to a housing 19 that accommodates the movement converter 51, and a flat or toothed belt 18.

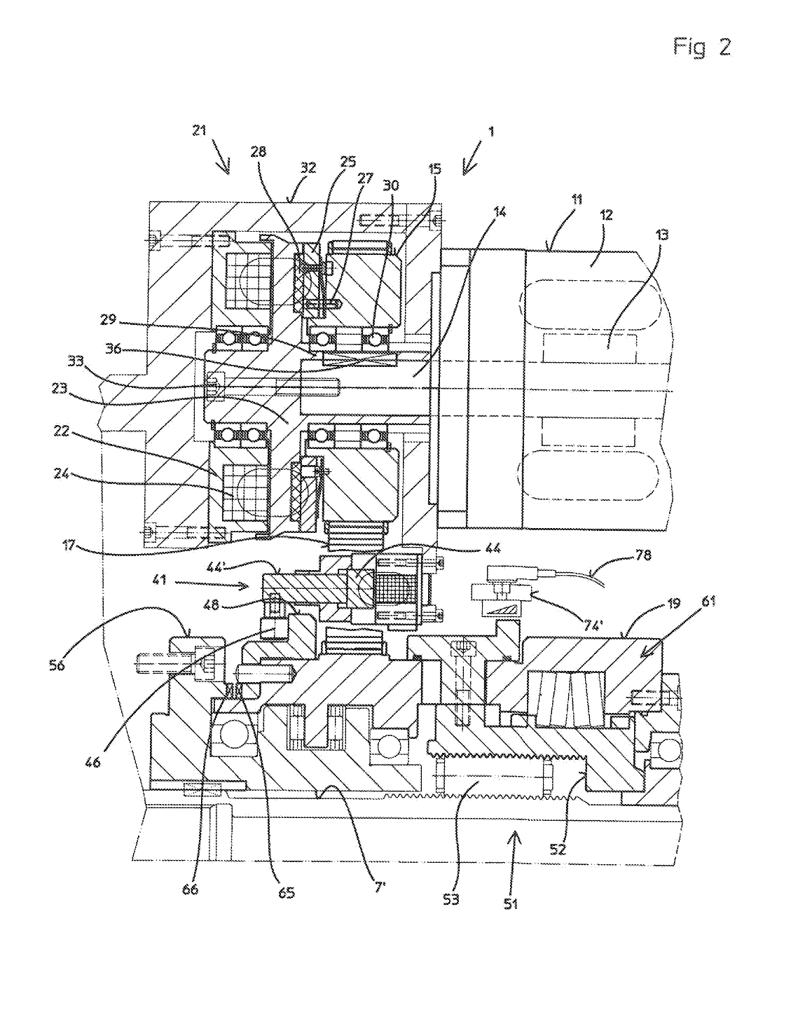

The output element 15 can be connected in a driving connection with the output shaft 14 of the drive motor 11 by means of a first servo device 21. Using a second servo device 41, the housing 19 can be connected to a spindle 3 of the machine tool 2 by means of an adjusting ring 48 so that, as shown in FIG. 2, when the first servo device 21 is activated and energy is transferred to the second servo device 41 from the drive motor 11 on the servo device 41, and from this to the draw rod 7, 7′, with the result that the clamping jaws 6 of the power-operated chuck 5 can be adjusted for opening and closing the power-operated chuck 5.

If, on the other hand, as shown in FIG. 1, the first servo device 21 is depressurised and the second servo device 41 is also depressurised, the housing 19 is connected to the spindle 3 of the machine tool by means of the adjusting ring 48. By means of the belt pulley 17 and the belt drive 18, the output element 15, in a rotating mounting forming the belt pulley 16, is also driven. The drive motor 11 is stopped in this operating position, i.e. in the working procedures to be undertaken on the machine tool 2.

In the embodiments shown in FIGS. 1, 2 and 3, as well as 5, the first servo device 21 is configured as an electromagnetically actuated clutch consisting of two housing components 22 and 23, a magnetic coil 24, as well as an armature 25. The housing component 22, accommodating the magnetic coil 24 in this case, is in a rotating mounting on the housing component 23 by means of an anti-friction bearing 31, in which case the housing component 23 is firmly connected to the rotor shaft 14 by means of a wedge 36 as well as a screw 37. In addition, a friction lining 28 is inserted in the housing component 23 on the end and, as shown in FIG. 2, the armature 25 makes contact with the friction lining 28, against the force of return springs 26, when the servo device 21 is actuated.

In this case, the armature 25 is held in an axially movable arrangement on pins 27 that are inserted into the output element 15, as a result of which a rotationally rigid connection is created between them. Furthermore, the housing component 23 is provided on an attachment in the form of a hub 29 extending in the direction of the drive motor 11, with the output element 15 in a rotating mounting on the hub 29 by means of anti-friction bearings 30. This means that the armature 25, friction lining 28, and housing component 23 connect the output element 15 to the rotor shaft 14 when the servo device 21 is activated, as a result of which there is a driving connection between the drive motor 11 and the motion converter 41, and via this, to the draw rod 7′.

In the embodiment shown in FIGS. 1 to 3, the first servo device 21 and the output element 25 are inserted in a two-part housing 32 on which the drive motor 11 is flange-mounted at the side in parallel with the lengthways axis A of the clamping device 1. Screws 34 attach the housing component 22 of the first servo device firmly to the housing 32. A signal line 35 carries both electrical energy for excitation and control signals to the magnetic coil 24 of the first servo device 21.

The second servo device 41 is also configured as an electromagnetically operated clutch, with a magnetic coil 43 and an armature 44 interacting with the magnetic coil 43 inserted in a housing 42. In this embodiment, an attachment 44′ is formed onto the armature 44, with anti-friction bearings 47 supported on pins 46 attached to the attachment 44′. The anti-friction bearings 47 allow the armature 44 to act on the adjusting ring 48 when electrical energy is supplied via a signal line 45, as a result of which the adjusting ring 48 is pushed against the force of return springs 49 to the right-hand limit position as shown in FIG. 2. By means of pins 59, the adjusting ring 48 is connected to the housing 19 accommodating the movement converter 41 in a rotationally fixed arrangement, but can be moved axially in relation to it.

If, however, as shown in FIG. 1, the second servo device 41 is depressurised, then the force of the return springs 49 pushes the adjusting ring 48 to the left. Gearing 65 attached to the side of the adjusting ring 48 engages in this case in mating gearing 66 worked onto an intermediate element 56, as a result of which the housing 19 of the movement converter 41 attached via the adjusting ring 48 in a rotationally fixed arrangement to the intermediate element 56 attached by screws 60 to the spindle 3 of the machine tool 2 is connected in a rotationally fixed arrangement to the spindle 3 and rotates together with it during working procedures.

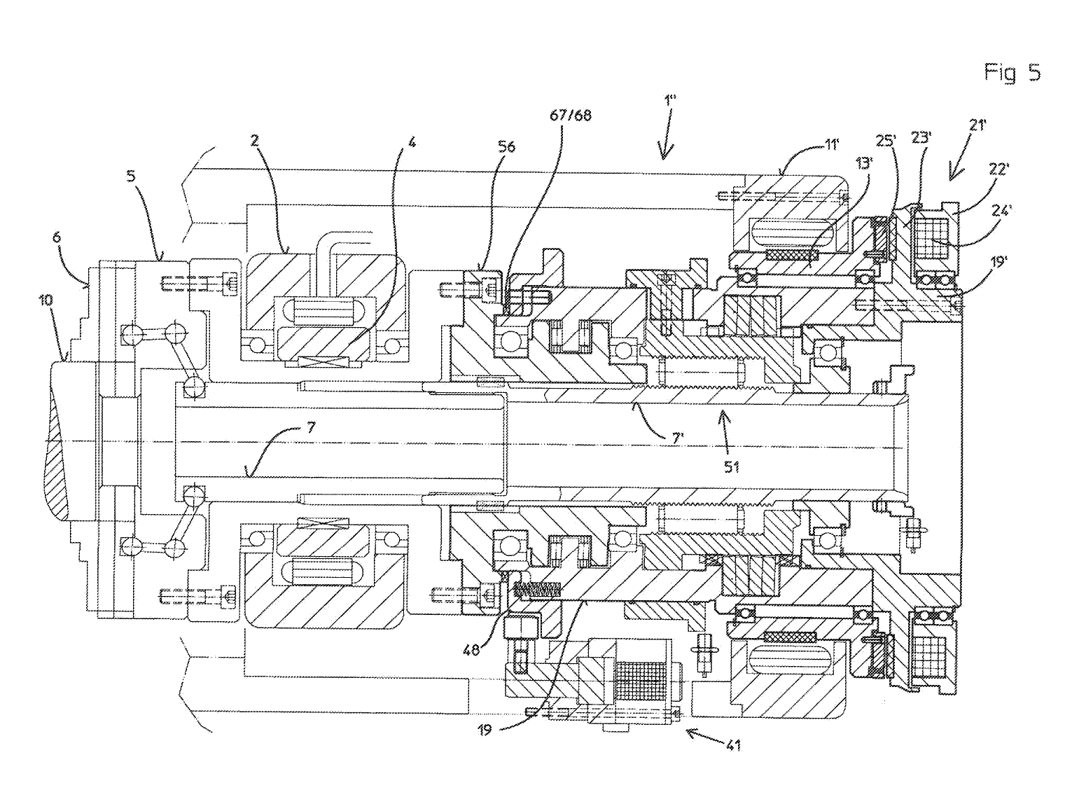

Furthermore, FIG. 5 shows that the adjusting ring 48 can also be supported via friction linings 67 and 68 in a non-positive arrangement on the intermediate element 56 that is attached to a flange 9 of the machine spindle 3.

In all embodiments, the movement converters 51 each comprise a spindle nut 52 and anti-friction bodies 53. The anti-friction bodies 53 engage in threads 54 or 55 worked onto the spindle nut 52 and the draw rod 7′, and the threads 54 or 55 provide a driving connection for the spindle nut 52 and the draw rod 7′, so that when the spindle nut 52 is turned by the drive motor 11, the draw rod 7′ is moved axially for clamping or unclamping the power-operated chuck 5.

Bearings 57 and 58 mount the movement converter 51 and the housing 19 accommodating a force accumulator 61 in a rotating arrangement on the intermediate element 56 that is in a rotationally fixed connection with the machine spindle 3. During working procedures, this means the housing 19 of the movement converter 41 arranged within it, as well as the force accumulator 61, which comprises spring packs 62 and 63 made up of cup springs 64, are driven by the spindle 3 of the machine tool 2. Also, because the input element is mounted in a rotating arrangement on the rotor shaft 14, it also rotates when the drive motor 11 is stationary.

A signal line 72 connects the drive motor 11 to a central computing unit 71. In addition, the first servo device 21 is connected to the computing unit 71 via the signal line 35, and the second servo device 41 is connected to the computing unit 71 via the signal line 45. Also, the adjustment travel of the spindle nut 52 is recorded by means of a setting ring 73 that is attached to the machine spindle 52 and passes through its by means of a slot 20; by means of a limit switch 74 attached to the setting ring 73, it is possible to record positions of the spindle nut 52.

In accordance with FIG. 2, instead of the limit switch 74, it is also possible to provide a distance measuring device 74′. A further distance measuring device 76 allocated to the draw rod 7′ and interacting with a setting ring 75 also makes it possible to ascertain the particular position of the draw rod 7′. Control lines 77, 78 or 79 also carry the signals obtained from the limit switch 74 or the distance measuring devices 74′ and 76 to the computing unit 71 where they are evaluated, as a result of which the particular operating position of the clamping device is known.

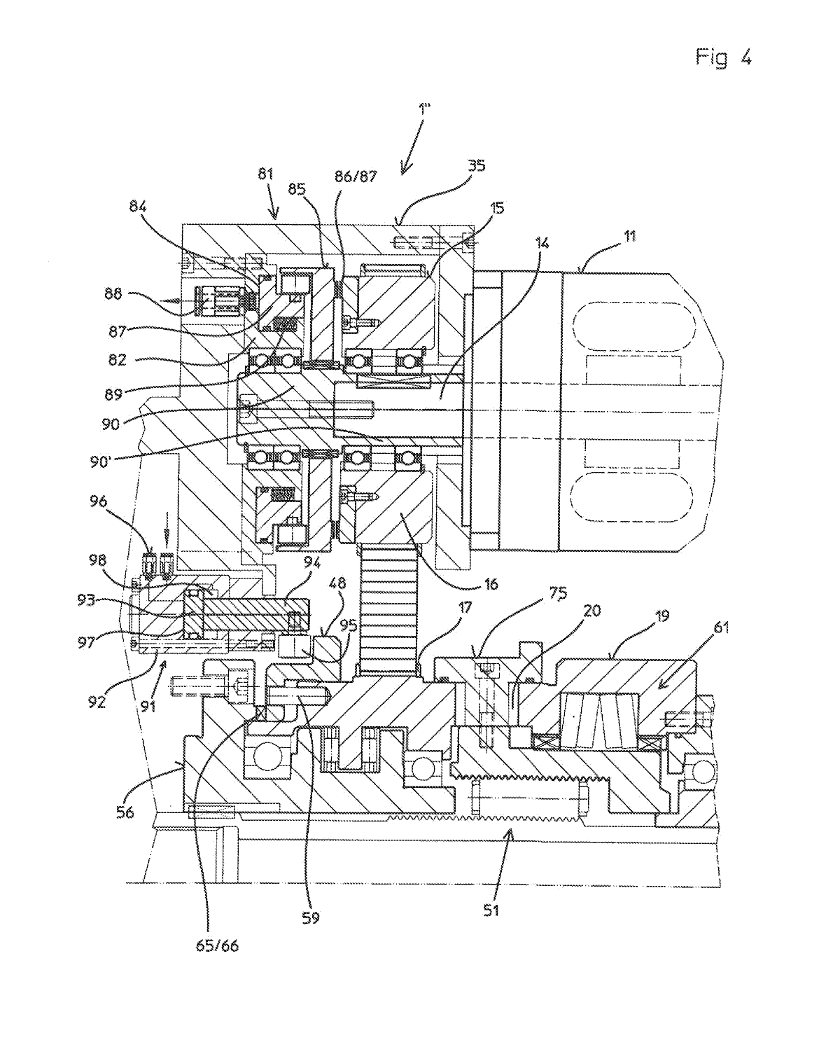

In accordance with FIG. 4, the first servo device 81 and the second servo device 91 can also be configured as hydraulically or pneumatically actuated clutches. Adjustment pistons 83 or 93 are inserted in a cylinder 82 or 92 in this case, and can be acted on by a pressurised fluid.

In the servo device 81, a pressurised chamber is provided in the cylinder 82. The piston 83 that can be moved against the return springs 49 acts on an actuator 85 in this case which is provided with spur gearing 86 that can be inserted into mating gearing 87 attached to the output element 15 when the adjustment piston 83 is pressurised by a supply line 88. When the gearing 86, 87 is engaged, the output element 15 is in a rotationally fixed connection with the rotor shaft 14 of the drive motor 11 by means of the actuator 85 and a carrier 90 connected to it, in which case the carrier 90 has a hub 90′ formed onto it and is in a driving connection with the rotor shaft 14.

In the servo device 81, on the other hand, the adjustment piston 93 is equipped with a piston rod 94 and two pressure chambers 97 and 98 are provided in a cylinder 92 with the effect that the adjustment piston 93 can be pushed to the right when pressurised fluid is supplied via connection 96 in order to disengage the gearing 65 and 66, and can be pushed to the left by the force of the return springs 49 in order to disengage the gearing 65 and 66.

In the embodiment of the clamping device 1″ according to FIG. 5, the rotor 13 of the drive motor in 11 is rotatably mounted directly on the housing 19 that accommodates the movement converter 51. The armature 25′ of the servo device 21′ in this case is attached in an axially movable arrangement to the rotor 13, and the housing components 22′ and 23′ including the magnetic coil 24′ are supported on an intermediate piece 19′ that is attached to the housing 19. In this way, a compact design is produced with a large usable internal diameter for the clamping device 1″.

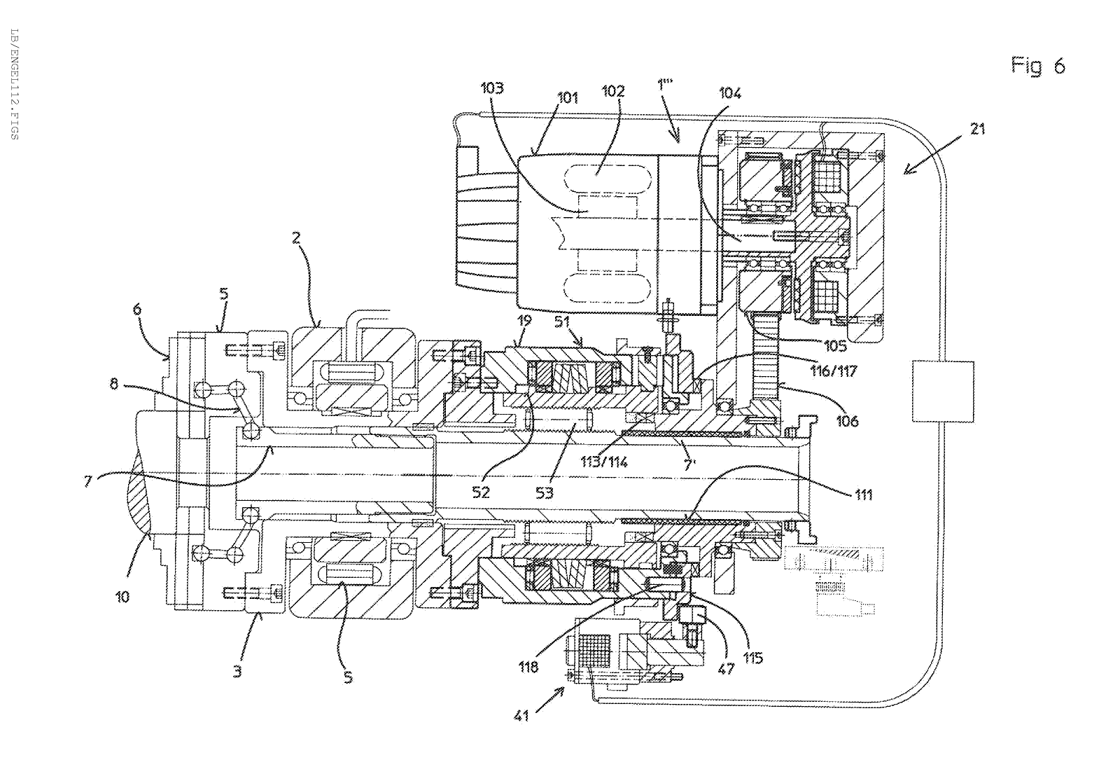

In the clamping device 1′″ shown in FIG. 6, the drive motor 101 does not act on the housing 19 accommodating the movement converter 51, but rather acts directly on its spindle nut 52. To achieve this, an intermediate element 111 is mounted on the draw rod 7′ in a rotating arrangement at the side next to the housing 19, and the intermediate element 111 is connected to the spindle nut 52 in a positive connection via cams 113, 114. In addition, a belt drive 106 is connected to the intermediate element 111, as the result of which the drive energy taken from a rotor shaft 104 of the drive motor 101 comprising a stator 102 or a rotor 103 for adjusting the clamping jaws 6 of the power-operated chuck 5 is input into the spindle nut 52 of the movement converter 51 when the first servo device 21 is closed, by means of an output element 105, the belt drive 106, and the intermediate element 111, and the drive energy is transmitted from there to the draw rod 7′.

An adjustment element 115 is to be actuated by means of the second servo device 41, with the adjustment element 115 allowing the gearing 116 and 117 provided on it, and on the spindle nut 52, to be engaged and disengaged. The adjustment element 115 is connected by pins 118 in a rotationally fixed connection to the housing 19 attached to the machine spindle 3, which means the clamping device 1′″ is blocked for working procedures when the gearing 116 and 117 is engaged.

1. A clamping device for machine tools, the device provided with a power-operated chuck for holding a workpiece, and clamping jaws of the chuck are adapted to be actuated using the clamping device by means of an axially moveable draw rod, in which the clamping device includes an electric drive motor with a changeover function for triggering clamping movements, a movement converter for converting the adjustment movements of the rotor shaft of the drive motor into axial adjustment movements of the draw rod required for actuating the clamping jaws, as well as a force accumulator for maintaining the clamping force, which is comprised of preloaded spring packs supported on a spindle nut of the movement converter,
wherein,
an output element is rotatably mounted on the output shaft of the rotor, and is continuously in a driving connection with the movement converter, the output element is adapted to be connected to the output shaft of the rotor by means of a first servo device, and the movement converter is adapted to be interlocked with the spindle of the machine tool by means of a second servo device, or by the force of springs, directly or via intermediate elements.

2. The clamping device in accordance with claim 1,
wherein
the movement converter and the force accumulator are inserted in a bell-shaped housing in a driving connection with the output element mounted on the output shaft of the rotor.

3. The clamping device in accordance with claim 1,
wherein
a housing is connected in a positive connection to the spindle nut of the movement converter by cam-shaped drivers.

4. The clamping device in accordance with claim 1,
wherein
the drive energy is transferred to the spindle nut of the movement converter by an intermediate element adapted to be connected via a belt drive to an output element of a drive motor and placed in a positive connection with the spindle nut via a driver arranged at a side next to said movement converter.

5. The clamping device in accordance with claim 2,
wherein
in order to provide a driving connection between the output element and the housing accommodating said movement converter, a a toothed belt drive or a gear connection, is provided.

6. The clamping device in accordance with claim 1,
wherein
a driving connection or the gear connection between the output element of the drive motor and the housing of said movement converter is configured with a step-down, step-up, or 1:1 ratio.

7. The clamping device in accordance with claim 6,
wherein
the first servo device and/or the second servo device are electromagnetically, or pneumatically, or hydraulically, operated clutches.

8. The clamping device in accordance with claim 7,
wherein
in an electromagnetically operated servo device, components are adapted to be connected by a selected one of friction elements, comprising toothed discs provided with pointed gearing, and discs equipped with fluting and knurling.

9. The clamping device in accordance claim 8,
wherein
an armature of the electromagnetically operated clutch of the servo device is supported against the output element by return springs means.

10. The clamping device in accordance with claim 7,
wherein
the second servo device interacts with an adjusting ring connected to a housing of said movement converter in a rotationally fixed arrangement, in which case on the side of the adjusting ring facing the spindle of the machine tool, the adjusting ring is provided with gearing, or a friction lining that interacts with mating gearing, or another friction lining provided on the machine spindle.

11. The clamping device in accordance with claim 10,
wherein
the adjusting element of the second servo device is in a driven connection with the adjusting ring by means of one or more radially aligned pins provided with anti-friction bearings, or by means of an angle piece.

12. The clamping device in accordance with claim 1,
wherein
the first servo device comprises an electromagnetically operated clutch, and comprises a first housing component located in a fixed arrangement and holding the magnetic coil, and a second housing component mounted so as to be adapted to turn in relation to said first housing component, said second housing component being in a permanent connection with the rotor shaft of the drive motor.

13. The clamping device in accordance with claim 12,
wherein
an armature of the electromagnetically operated clutch is coupled to the output element of the drive motor in a rotationally rigid but axially movable arrangement.

14. The clamping device in accordance with claim 13,
wherein
the first servo device is arranged in a housing with the output element of the drive motor, and the drive motor is flange-mounted on the outside of the housing.

15. The clamping device in accordance with claim 1,
wherein
when the first servo device comprises an electromagnetically operated clutch, the housing component facing the drive motor is provided with an attachment configured as a hub, upon which the output element is rotatably mounted.

16. The clamping device in accordance with claim 3,
wherein
the housing accommodating said movement converter is mounted in a rotating arrangement on an intermediate piece in a permanent connection with the spindle of the machine tool.

17. The clamping device in accordance with claim 1,
wherein
the rotor of the drive motor is adapted to be mounted in a rotating arrangement on the housing accommodating said movement converter.

18. The clamping device in accordance with claim 13,
wherein
said armature of the electromagnetically operated servo device is axially movable directly on the rotor of the drive motor, and the housing components, including the magnetic coil, are supported on an intermediate piece attached to the housing of said movement converter.

19. The clamping device in accordance with claim 6,
wherein
the drive motor, the first servo device, and the second servo device are jointly controllable by means of a central computing unit.

20. The clamping device in accordance with claim 1,
wherein
a distance measuring device and a limit switch are allocated to the spindle nut of said movement converter, the signals from which are adapted to be received outside the housing of said movement converter.

21. The clamping device in accordance with claim 1,
wherein
a distance measuring device is allocated to the draw rod (7, 7′) and disposed at an end area thereof facing away from the machine tool.

22. A process for operating a clamping device for a machine tool provided with a power-operated chuck for holding a workpiece, and clamping jaws adapted to be actuated using the clamping device by means of an axially moveable draw rod, wherein the clamping device includes an electric drive motor with a changeover function for triggering clamping movements, a movement converter for converting the adjustment movements of the rotor shaft of the drive motor into the axial adjustment movements of the draw rod required for actuating the clamping jaws, and a force accumulator for maintaining clamping force, and comprising preloaded spring packs supported on a spindle nut of said movement converter,
wherein
a first servo device and a second servo device in the clamping device adapted to be controlled in a same direction, or in parallel, or alternately, by means of a common computing unit depending on the operating status of the clamping device, such that when the first servo device is activated to transfer drive energy to said movement converter, the rotor shaft of the drive motor is connected to its output element and the second servo device is connected such that the driving connection between the housing and the spindle of the machine tool is released, and when there is a modification in the working procedure of the machine tool, as when clamping or unclamping the workpiece, the first servo unit is opened, the second servo device is opened, or actuated, and the housing of said movement converter is in a driving connection with the spindle of the machine tool.
